(19) United States
(12) Patent Application Publication
(10) Pub. No.: US 2014/0142214 A1
(43) Pub. Date: May 22, 2014

(54) RUBBER COMPOSITION AND TIRE

(71) Applicant: The GOODYEAR TIRE & RUBBER COMPANY, Akron, OH (US)

(72) Inventors: Elena Sperotto, Luxembourg (LU); Frank Schmitz, Bissen (LU); Giorgio Agostini, Colmar-Berg (LU)

(21) Appl. No.: 13/681,624

(22) Filed: Nov. 20, 2012

(51) Int. Cl. C08K 5/39

(52) U.S. Cl. CPC C08K 5/39
USPC 523/156; 524/201

(57) ABSTRACT

The present invention is directed to a rubber composition comprising at least one diene based elastomer; an α,ω-bis(N,N′-dihydrocarbylthiocarbamamoyldithio)alkane; and sulfur in a form selected from the group consisting of elemental sulfur and insoluble sulfur; wherein the rubber composition is essentially free of cure accelerators.

The invention is further directed to a pneumatic tire comprising the rubber composition.

### BACKGROUND OF THE INVENTION

Various tire constructions have been suggested for pneumatic runflat tires; that is, tires capable of being used while uninflated (with total loss of air pressure other than ambient atmospheric pressure). A vehicle equipped with such tires can continue to be driven after the tire experiences loss of pneumatic pressure, such as loss of air pressure caused by puncture or valve failure. This is highly desirable since it allows vehicles equipped with such runflat tires to continue in operation until they reach a location where the tire can be repaired or replaced. Tires of this type are sometimes also referred to as extended mobility tires (EMT).

The goal of engineering has been to develop a runflat tire without compromising ride or performance. In sports cars having relatively stiff suspension characteristics, the ability to provide such a runflat tire was comparatively easy as compared to providing such tires for luxury sedans that demand softer ride characteristics. Light truck and sport utility vehicles, although not as sensitive to ride performance, typically utilize tires having a relatively high aspect ratio which makes the requirements for the runflat tire more challenging.

In the case of runflat tires made utilizing stiff inserts, the insert carries most of the load on the tire during periods of operation after loss of air pressure. This leads to the generation of heat. Heat build-up can then lead to thermal degradation in the insert. A reduction in crosslink density and a change in the distribution of crosslink types is the result of this thermal degradation. Thermal degradation can accordingly limit the distance over which the runflat tire can be used during periods of operation after air loss.

### SUMMARY OF THE INVENTION

The present invention is directed to a rubber composition comprising at least one diene based elastomer; an α,ω-bis(N,N′-dihydrocarbylthiocarbamamoyldithio)alkane; and sulfur in a form selected from the group consisting of elemental sulfur and insoluble sulfur; wherein the rubber composition is essentially free of cure accelerators.

The invention is further directed to a pneumatic tire comprising the rubber composition.

### BRIEF DESCRIPTION OF THE DRAWINGS

FIG. 1 is a fragmentary cross-sectional view of a tire showing its tread and carcass with one ply and one insert axially inward of the ply in the sidewall region of the tire as an embodiment of the invention.

FIG. 2 is a fragmentary cross-sectional view of a tire showing its tread and carcass with two plies, a second insert interposed between the plies and a second ply axially outward of the innermost ply in the sidewall region of the tire as an embodiment of the invention.

FIG. 3 is a fragmentary cross-sectional view of a tire showing its tread and carcass with three plies, inserts between the plies and another insert axially inward of the innermost ply in the sidewall region of the tire as an embodiment of the invention.

FIG. 4 illustrates the effect of varying the sulfur content in a rubber composition while holding accelerator and modifier contents constant.

FIG. 5 illustrates the effect of varying the accelerator content in the rubber composition while holding sulfur and modifier contents constant.

FIG. 6 illustrates the effect of varying the modifier content in the rubber composition while holding sulfur and accelerator contents constant.

### DETAILED DESCRIPTION OF THE INVENTION

There is disclosed a rubber composition comprising at least one diene based elastomer; an α,ω-bis(N,N′-dihydrocarbylthiocarbamamoyldithio)alkane; and sulfur in a form selected from the group consisting of elemental sulfur and insoluble sulfur; wherein the rubber composition is essentially free of cure accelerators.

There is further disclosed a pneumatic tire comprising the rubber composition.

In one embodiment, the rubber composition is further vulcanizable.

In one embodiment, the vulcanization state of the rubber composition is between its T₂₅ and T₈₀ vulcanization states.

In one embodiment, the rubber composition has a first modulus and a second modulus, the first modulus existing after the normal cure cycle of a runflat tire, and the second modulus obtainable during a runflat condition of the tire, wherein the second modulus is greater than the first modulus.

In one embodiment, to obtain a rubber composition wherein the rubber composition is further vulcanizable, at least one vulcanization modifier may be added to the rubber composition. By “vulcanization modifier,” it is meant that such a vulcanization modifier will have the effect of affecting the vulcanization of the rubber composition during the normal cure cycle of the rubber composition, such that the vulcanization state in the rubber composition is less than its fully cured vulcanization state after the normal cure cycle. The rubber composition is capable of further cure to a more fully cured vulcanization state upon experience of a higher temperature environment, such as a tire deflation during a runflat event in a runflat tire.

A cured rubber composition, for the purposes of the discussion for this invention, is a sulfur cured rubber composition, conventionally a sulfur cured diene-based rubber, which has been cured to a substantial inflection of its modulus (y axis) versus time (x axis) curve. Depending on the method used to measure the cure kinetics, a property related to modulus, such as torque, may be used. In particular, such curve conventionally is a curve with a positive slope which rises over time until it experiences a substantial inflection in a manner that its slope reaches a plateau where it becomes substantially horizontal. In such region of a slope transition, which is somewhat of a maximization of the slope, although the slope might still very gradually rise, it is considered that the rubber composition is fully cured. In the presence of a vulcanization modifier, the shape of the curve may be somewhat modified, depending on the modifier used. The net effect of the vulcanization modifier is to modify the vulcanization of the rubber composition such that the rubber composition exists in a first vulcanization state after the normal cure cycle for example in a sidewall insert of a runflat tire, and the rubber composition may obtain a second vulcanization state upon experience of a higher temperature environment, such as a tire deflation during a runflat event.

In one embodiment, the vulcanization state of the rubber composition is between its T₂₀ and T₈₀ vulcanization states after the normal cure cycle. In another embodiment, the vulcanization state of the rubber composition is between its T₄₀ and T₆₀ vulcanization states after the normal cure cycle. The rubber composition is further vulcanizable and may obtain a second vulcanization state upon experience of a higher temperature environment, such as a tire deflation during a runflat event. The “T-points” (ie, T₉₀, T₂₅, T₈₀, etc.) represent vulcanization states, are recognizable to one skilled in the art and are defined in ASTM D2084, D5289 and ISO 6502 and are fully described in a presentation given by H. G. Buhrin at Tyretech '90 in Brighton, England, Nov. 5-6 1990. The T-points may be determined using the Flexsys Rubber Process Analyzer (RPA) 2000. A description of the RPA 2000, its capability, sample preparation, tests and subtests can be found in these references. H A Pawlowski and J S Dick, Rubber World, June 1992; J S Dick and H A Pawlowski, Rubber World, January 1997; and J S Dick and J A Pawlowski, Rubber & Plastics News, Apr. 26 and May 10, 1993.

By allowing the rubber composition of the insert to be in less than its fully cured vulcanization state after the normal cure cycle for the runflat tire, it is contemplated that upon experience a deflation event, the heat generated during the event will cause the rubber composition to further cure with an increase in stiffness (modulus) delaying the onset of degradation of the insert. The driver thereby gains precious time to slow and stop before degradation of the insert. The less than fully cured rubber composition also imparts a degree of softness to the insert, which affords a more comfortable ride on the runflat tires during normal use.

In one embodiment, the vulcanization modifier for use in the rubber composition is an α,ω-bis(N,N′-dihydrocarbylthiocarbamamoyldithio)alkanes.

In one embodiment, the vulcanization modifier is a α,ω-bis(N,N′-dihydrocarbylthiocarbamamoyldithio)alkanes. Suitable α,ω-bis(N,N′-dihydrocarbylthiocarbamamoyldithio)alkanes include 1,2-bis(N,N′-dibenzylthiocarbamoyl-dithio)ethane; 1,3-bis(N,N′-dibenzylthiocarbamoyldithio)propane; 1,4-bis(N,N′-dibenzylthiocarbamoyldithio)butane; 1,5-bis(N,N′-dibenzylthiocarbamoyl-dithio)pentane; 1,6-bis(N,N′-dibenzylthiocarbamoyldithio)hexane; 1,7-bis(N,N′-dibenzylthiocarbamoyldithio)heptane; 1,8-bis(N,N′-dibenzylthiocarbamoyl-dithio)octane; 1,9-bis(N,N′-dibenzylthiocarbamoyldithio)nonane; and 1,10-bis(N,N′-dibenzylthiocarbamoyldithio)decane. In one embodiment, the vulcanization modifier is 1,6-bis(N,N′-dibenzylthiocarbamoyldithio)hexane available as Vulcuren® from Lanxess.

In one embodiment, the rubber composition may comprise from about 1 to about 10 parts by weight, per 100 parts by weight of elastomer (phr), of the vulcanization modifier. In another embodiment, the rubber composition may comprise from about 2 to about 8 phr of vulcanization modifier.

The present invention may be used with rubbers or elastomers containing olefinic unsaturation. The phrase “rubber or elastomer containing olefinic unsaturation” is intended to include both natural rubber and its various raw and reclaim forms as well as various synthetic rubbers. In the description of this invention, the terms “rubber” and “elastomer” may be used interchangeably, unless otherwise prescribed. The terms “rubber composition”, “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are polybutadiene and SBR.

In one aspect the rubber is preferably of at least two of diene based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

In one aspect of this invention, an emulsion polymerization derived styrene/butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, cis 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

The term “phr” as used herein, and according to conventional practice, refers to “parts by weight of a respective material per 100 parts by weight of rubber, or elastomer.”

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, napthenic, vegetable oils, and low PCA oils, such as MES, TDAE, SRAE and heavy naphthenic oils.

The phrase “rubber or elastomer containing olefinic unsaturation” is intended to include both natural rubber and its various raw and reclaim forms as well as various synthetic rubbers. In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials, and such terms are well known to those having skill in the rubber mixing or rubber compounding art.

The vulcanizable rubber composition may include from about 10 to about 150 phr of silica.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP, Z165GR and Zeosil Premium 200 MP and silicas available from Degussa AG with, for example, designations VN2 and VN3, etc.

The vulcanizable rubber composition may include from 1 to 100 phr of carbon black, crosslinked particulate polymer gel, ultra high molecular weight polyethylene (UHMWPE) or plasticized starch.

Commonly employed carbon blacks can be used as a conventional filler. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers may be used in the rubber composition including, but not limited to, particulate fillers including ultra high molecular weight polyethylene (UHMWPE), particulate polymer gels including but not limited to those disclosed in U.S. Pat. Nos. 6,242,534; 6,207,757; 6,133,364; 6,372,857; 5,395,891; or 6,127,488, and plasticized starch composite filler including but not limited to that disclosed in U.S. Pat. No. 5,672,639.

In one embodiment the rubber composition for use in the tire tread may contain a conventional sulfur containing organosilicon compound. Examples of suitable sulfur containing organosilicon compounds are of the formula:

Z-Alk-Sₙ-Alk-Z I

in which Z is selected from the group consisting of

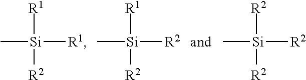

where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl) octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl) hexasulfide, 3,3′-bis(trimethoxysilylpropyl) octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxy diethoxy silyl ethyl)tetrasulfide, 2,2′-bis(tripropoxysilylethyl)pentasulfide, 3,3′-bis(tricyclonexoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenyl methyl methoxysilylethyl)trisulfide, 3,3′-bis(diphenyl isopropoxysilylpropyl)tetrasulfide, 3,3′-bis(diphenyl cyclohexoxysilylpropyl)disulfide, 3,3′-bis(dimethyl ethylmercaptosilylpropyl)tetrasulfide, 2,2′-bis(methyl dimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec. butoxysilylpropyl)disulfide, 3,3′-bis(propyl diethoxysilylpropyl)disulfide, 3,3′-bis(butyl dimethoxysilylpropyl)trisulfide, 3,3′-bis(phenyl dimethoxysilylpropyl)tetrasulfide, 3-phenyl ethoxybutoxysilyl 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis(dimethoxyphenylsilyl-2-methylpropyl)disulfide.

In one embodiment, the sulfur containing organosilicon compounds are the 3,3′-bis(trimethoxy or triethoxy silylpropyl) sulfides. In one embodiment, the sulfur containing organosilicon compounds are 3,3′-bis(triethoxysilylpropyl)disulfide and 3,3′-bis(triethoxysilylpropyl)tetrasulfide. Therefore, as to formula I, Z may be

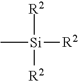

where R² is an alkoxy of 2 to 4 carbon atoms, alternatively 2 carbon atoms; alk is a divalent hydrocarbon of 2 to 4 carbon atoms, alternatively with 3 carbon atoms; and n is an integer of from 2 to 5, alternatively 2 or 4.

In another embodiment, suitable sulfur containing organosilicon compounds include compounds disclosed in U.S. Pat. No. 6,608,125. As disclosed in U.S. Pat. No. 6,608,125, these sulfur containing organosilicon compounds are of the formula G-C(══O)—S—CH₂CH₂CH₂SiX₃ wherein each X is an independently selected RO— group wherein each R is independently selected from the group consisting of hydrogen, alkyl that may or may not contain unsaturation, alkenyl groups, aryl groups, and aralkyl groups, such moieties other than hydrogen having from 1 to 18 carbon atoms, and G is a monovalent alkyl of from 6 to 8 carbon atoms. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from GE Silicones.

In another embodiment, suitable sulfur containing organosilicon compounds include those disclosed in U.S. Patent Publication 2003/0130535. As disclosed in U.S. Patent Publication 2003/0130535, these sulfur containing organosilicon compounds are of the formulas III or IV

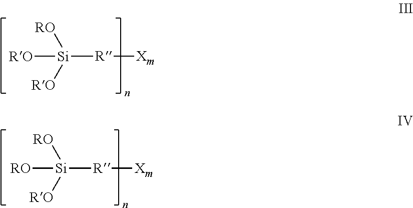

wherein: R is a methyl or ethyl group;

R′ is identical or different and is a C₉C₃₀ branched or unbranched monovalent alkyl or alkenyl group, aryl group, aralkyl group, branched or unbranched C₂-C₃₀ alkyl ether group, branched or unbranched C₂-C₃₀ alkyl polyether group or R″′₃Si, where R″′ is C₁-C₃₀ branched or unbranched alkyl or alkenyl group, aralkyl group or aryl group, R″ is a branched or unbranched, saturated or unsaturated, aliphatic, aromatic or mixed aliphatic/aromatic divalent C₁-C₃₀ hydrocarbon group;

X is SH where n=1 and m=1, S where n=2 and m=1-10 and mixtures thereof, S(C══O)—R′″ where n=1 and m=1 or H where n=1 and m=1;

R″ may mean CH₂, CH₂CH₂, CH₂CH₂CH₂, CH₂CH₂CH₂CH₂, CH(CH₃), CH₂CH(CH₃), C(CH₃)₂, CH(C₂H₅), CH₂CH₂CH(CH₃), CH₂CH(CH₃)CH₂ or

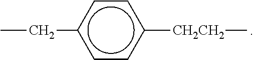

In one embodiment, the sulfur containing organosilicon compound is of formula III, R is ethyl, R′ is C₁₂-C₁₄ alkyl, R″ is CH₂CH₂CH₂, X is SH, n is 1 and m is 1. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids such as activators, and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

In typical rubber compositions, cure accelerators are used to control the time and/or temperature required for vulcanization and to improve the properties of the vulcanizate. In the present invention, no accelerator is used. Excluded accelerators for the present invention include but are not limited to amines, disulfides, guanidines, thioureas, thiazoles, thiurams, sulfenamides, dithiocarbamates and xanthates.

The rubber composition, as noted, excludes cure accelerators. However, as is known in the art some residual amount of cure accelerator may be present in mixing equipment and consequently appear in rubber compositions. The rubber composition is then said to be essentially free of cure accelerators. By essentially free, it is meant that the amount of cure accelerator, if any, is very low and is present only due to contamination by process equipment and normal handling in the material procurement process. In one embodiment, the amount of cure accelerator is less than 0.1 phr. In one embodiment, the amount of cure accelerator is less than 0.05 phr. In one embodiment, the about of cure accelerator is less than 0.01 phr.

The rubber composition may be described as consisting essentially of a diene based elastomer, an α,ω-bis(N,N′-dihydrocarbylthiocarbamamoyldithio)alkane; and sulfur in a form selected from the group consisting of elemental sulfur and insoluble sulfur. In this instance, and as will be demonstrated in the accompanying examples, by “consisting essentially of” means that while other typical compounding additives as described herein may be present in the rubber composition, cure accelerators are not included as they have a material and undesirable effect on the behavior of the rubber composition.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in a final stage which is conventionally called a “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. A thermomechanical mixing step generally comprises a mechanical working in a mixer or extruder for a period of time suitable in order to produce a rubber temperature between 140° C. and 190° C. The appropriate duration of a thermomechanical working varies as a function of the operating conditions, and the volume and nature of the components. For example, a thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat or innerliner. In one embodiment, the component is a tread.

The pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

In one embodiment, the rubber composition may be incorporated into a sidewall insert in a runflat tire.

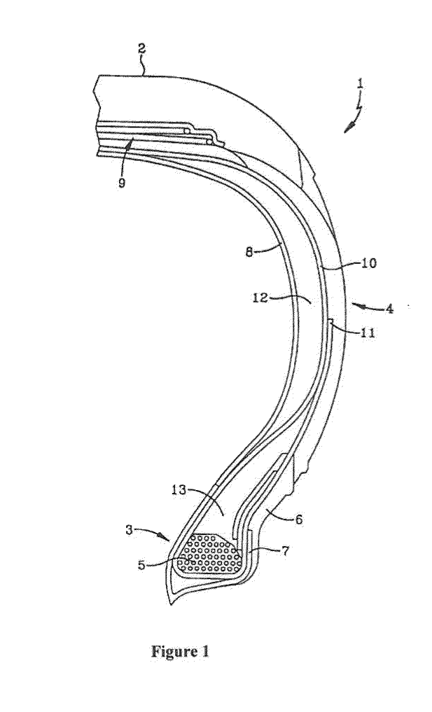

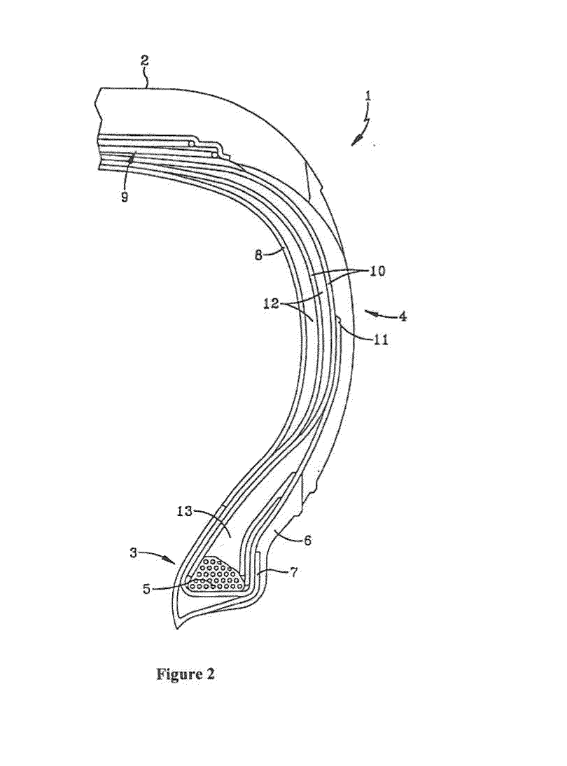

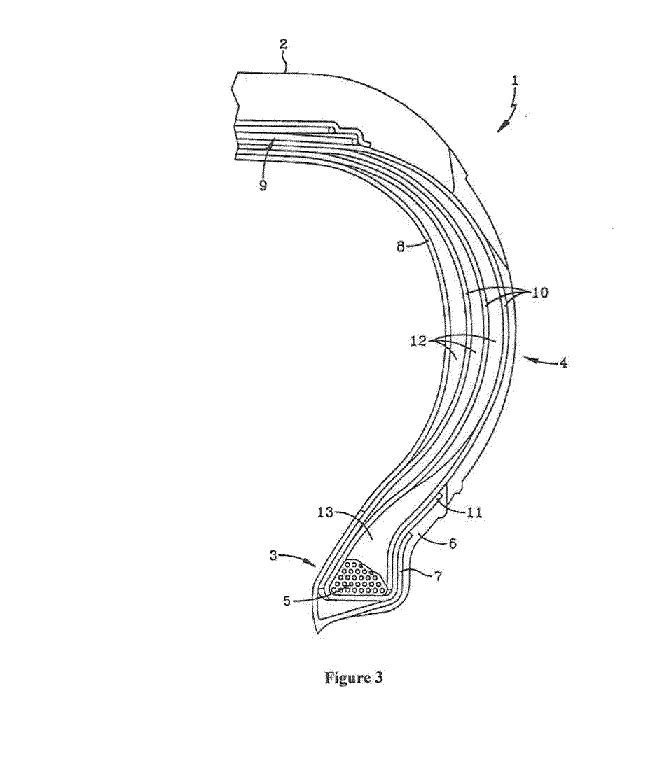

Referring to the drawings, FIGS. 1, 2 and 3 show the fragmentary cross-section of a runflat tire 1, its tread 2, bead portion 3, sidewall or sidewall region 4, inextensible wire bead core 5, rubber chafer 6, rubber toeguard 7, rubber composition innerliner 8, belt structure 9 underlying a portion of the tread 2, carcass ply 10, carcass ply turnup 11, insert 12 and apex 13.

The inserts 12 may extend from each bead region radially to the edge of the tread, usually to just beneath the reinforcing belt structures 9. As illustrated in the Figures, the sidewall portions may each include a first insert 12 and a second insert 12 and even a third insert 12. The first inserts 12 are positioned as described above. The second inserts 12 are located (interposed) between the first and the second plies 10, respectively. The second insert 12 extends from each bead region 3, or portion, radially outward to the edge of the tread 2, namely, to just beneath the reinforcing belt structure 9.

The tire of this invention can be built, shaped, molded and cured by various methods that will be readily apparent to those having skill in the art.

The invention is further illustrated by the following nonlimiting example.

### Example

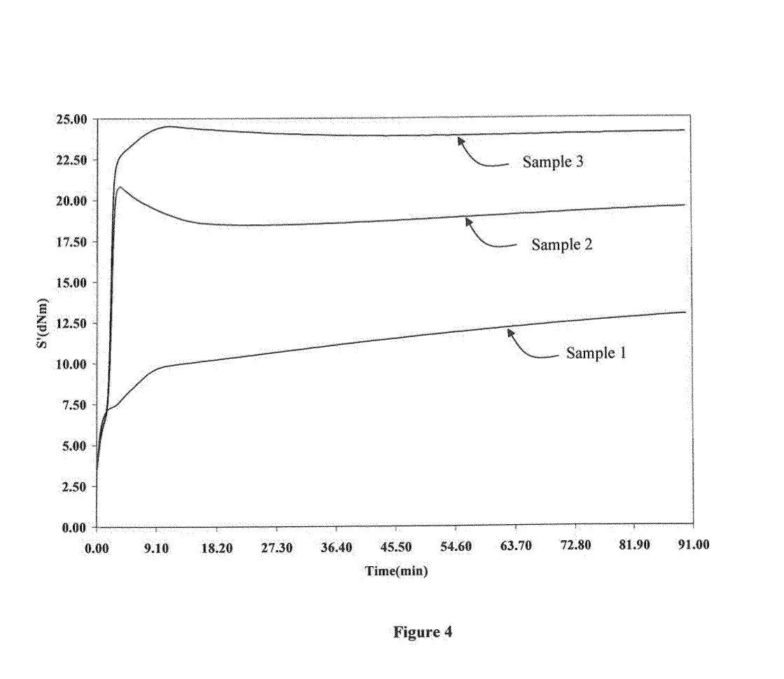

In this example, the effect of adding a vulcanization modifier to a rubber composition is illustrated. Seven samples were prepared following the recipes in Table 1, with amounts given in phr. Each composition was prepared in a multistage mix procedure with one non-productive stage and one productive stage. The samples were then tested for cure kinetics (moving die rheometer as model MDR-2000 by Alpha Technologies using a cure temperature of 160° C.) with results for torque S′ versus time as shown in FIGS. 4, 5 and 6.

TABLE 1

| | Sample | | | | | | |
|---|---|---|---|---|---|---|---|
| | 1 | 2 | 3 | 4 | 5 | 6 | 7 |
| Natural Rubber | 100 | 100 | 100 | 100 | 100 | 100 | 100 |
| Silica¹ | 55 | 55 | 55 | 55 | 55 | 55 | 55 |
| Coupling Agent² | 4.5 | 4.5 | 4.5 | 4.5 | 4.5 | 4.5 | 4.5 |
| Sulfur | 0 | 2 | 4 | 2 | 2 | 2 | 2 |
| Accelerator³ | 2 | 2 | 2 | 0 | 4 | 2 | 2 |
| Vulcanization | 2 | 2 | 2 | 2 | 2 | 0 | 4 |
| Modifier⁴ | | | | | | | |

¹Precipitated Silica type Zeosil Premium 200 MP from Rhodia
²bis (alkoxysilylalkyl)polysulfide type
³N-cyclohexyl benzothiazole-2-sulfenamide
⁴1,6-bis(N,N′-dibenzylthiocarbamoyldithio)hexane, as Vulcuren ® from Lanxess

FIG. 4 illustrates the effect of varying the sulfur content in the rubber composition while holding accelerator and modifier contents constant. As seen in FIG. 4, use of sulfur with accelerator and modifier results in rapid cure to a relative highly cured final cure state as indicated by the high torque at higher cure times (Samples 2 and 3) Elimination of sulfur as in Sample 1 results in rapid initial cure but a slower approach to a lower final cure state as compared to Samples 2 and 3.

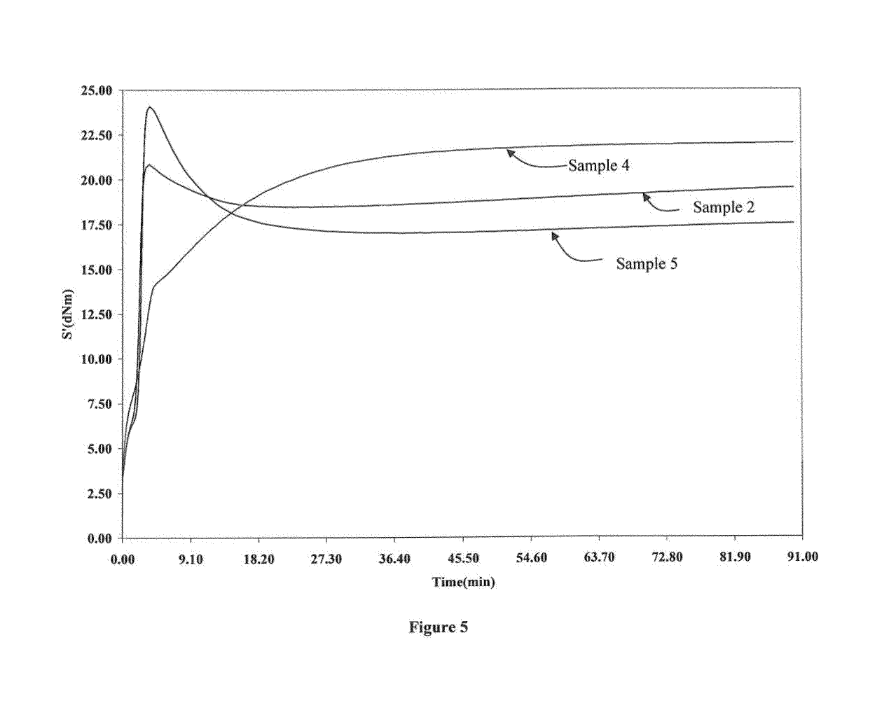

FIG. 5 illustrates the effect of varying the accelerator content in the rubber composition while holding sulfur and modifier contents constant. As seen in FIG. 5, use of accelerator with sulfur and modifier results in rapid cure to a relative highly cured final cure state as indicated by the high torque at higher cure times (Samples 2 and 5). Elimination of accelerator as in Sample 4 results in rapid initial cure to a lower cured state as compared to Samples 2 and 5, followed by a slow approach to a relatively highly cured final cure state.

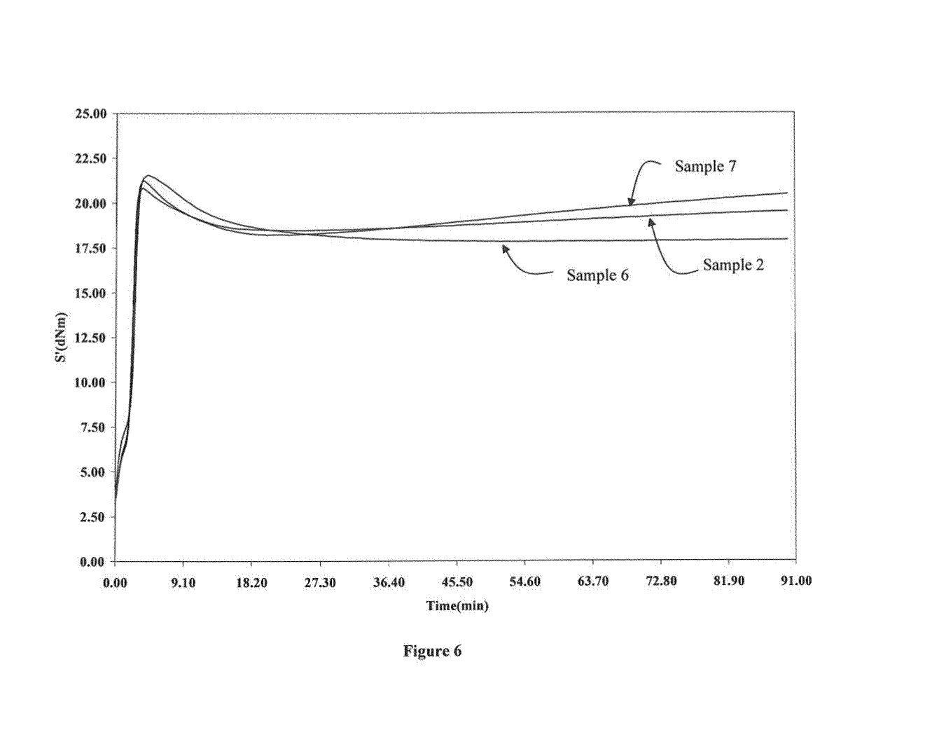

FIG. 6 illustrates the effect of varying the modifier content in the rubber composition while holding sulfur and accelerator contents constant. As seen in FIG. 6, variation in the modifier content has little effect on the cure profiles of the respective samples, with each showing a rapid initial cure to a relatively highly cured final cure state.

The results in FIGS. 4 through 6 indicate the surprising and unexpected result that elimination of the accelerator from the rubber composition as in Sample 4 gives a cure profile offering advantages in particular applications, where a partially cured composition is desirable. For example, in a runflat tire insert, under normal operating conditions an insert made from the partially cured composition as in Sample 4 would have a relatively low modulus, allowing a more comfortable ride. Upon deflation of the tire resulting from a puncture or the like, the rubber composition in the insert will experience a high temperature owing to the stresses imparted to the tire sidewall. The high temperature experience by the rubber composition in the sidewall insert will promote cure similar to that shown for Sample 4 in FIG. 5, allowing for a gradual increase in modulus and stiffness in the insert and improved endurance for the insert and mileage for the tire during the deflation event.

While certain representative embodiments and details have been shown for the purpose of illustrating the invention, it will be apparent to those skilled in this art that various changes and modifications may be made therein without departing from the spirit or scope of the invention.

What is claimed is:

1. A rubber composition consisting essentially of:
at least one diene based elastomer;
an α,ω-bis(N,N′-dihydrocarbylthiocarbamamoyldithio)alkane; and
sulfur in a form selected from the group consisting of elemental sulfur and insoluble sulfur;
wherein the rubber composition is essentially free of cure accelerators.

2. A rubber composition comprising at least one diene based elastomer; an α,ω-bis(N,N′-dihydrocarbylthiocarbamamoyldithio)alkane; and sulfur in a form selected from the group consisting of elemental sulfur and insoluble sulfur; wherein the rubber composition is essentially free of cure accelerators.

3. The rubber composition of claim 1, wherein the α,ω-bis(N,N′-dihydrocarbylthiocarbamamoyldithio)alkane is selected from the group consisting of 1,2-bis(N,N′-dibenzylthiocarbamoyl-dithio)ethane; 1,3-bis(N,N′-dibenzylthiocarbamoyldithio)propane; 1,4-bis(N,N′-dibenzylthiocarbamoyldithio)butane; 1,5-bis(N,N′-dibenzylthiocarbamoyl-dithio)pentane; 1,6-bis(N,N′-dibenzylthiocarbamoyldithio)hexane; 1,7-bis(N,N′-dibenzylthiocarbamoyldithio)heptane; 1,8-bis(N,N′-dibenzylthiocarbamoyl-dithio)octane; 1,9-bis(N,N′-dibenzylthiocarbamoyldithio)nonane; and 1,10-bis(N,N′-dibenzylthiocarbamoyldithio)decane.

4. The rubber composition of claim 2, wherein the α,ω-bis(N,N′-dihydrocarbylthiocarbamamoyldithio)alkane is 1,6-bis(N,N′-dibenzylthiocarbamoyldithio)hexane.

5. The rubber composition of claim 2, wherein the cure accelerator is selected from the group consisting of amines, disulfides, guanidines, thioureas, thiazoles, thiurams, sulfenamides, dithiocarbamates and xanthates.

6. The rubber composition of claim 2, wherein the amount of cure accelerator is less than 0.1 phr.

7. The rubber composition of claim 2, wherein the amount of cure accelerator is less than 0.05 phr.

8. The rubber composition of claim 2, wherein the amount of cure accelerator is less than 0.01 phr.

9. The rubber composition of claim 2, wherein the rubber composition comprises
100 parts by weight of at least one diene-based elastomer; and
from about 1 to about 10 parts by weight, per 100 parts by weight of elastomer, of the α,ω-bis(N,N′-dihydrocarbylthiocarbamamoyldithio)alkane.

10. The rubber composition of claim 2, wherein the rubber composition comprises
100 parts by weight of at least one diene-based elastomer; and from about 2 to about 8 parts by weight, per 100 parts by weight of elastomer, of the α,ω-bis(N,N′-dihydrocarbylthiocarbamamoyldithio)alkane.

11. The rubber composition of claim 2, wherein the diene based elastomer is selected from the group consisting of emulsion polymerized styrene/butadiene copolymers, solution polymerized styrene/butadiene copolymers, natural rubber, cis 1,4-polybutadiene, synthetic cis 1,4-polyisoprene, styrene/isoprene copolymers, 3,4-polyisoprene, isoprene/butadiene copolymers, medium vinyl polybutadiene (20 percent to 60 percent by weight of vinyl units), styrene/isoprene/butadiene terpolymers, butyl rubber, polychloroprene, acrylonitrile/butadiene copolymers and ethylene/propylene/diene terpolymers.

12. A pneumatic tire comprising at least one component, wherein the component comprises the rubber composition of claim 2.

13. The pneumatic tire of claim 12, wherein the component is selected from the group consisting of treads, sidewalls, apexes, chafers, sidewall inserts, wirecoats and innerliners.

14. A runflat tire comprising a sidewall insert, wherein the sidewall insert comprises the rubber composition of claim 2.
